(19) United States
(12) Patent Application Publication
(10) Pub. No.: US 2018/0104744 A1
(43) Pub. Date: Apr. 19, 2018

(54) METHOD FOR PRODUCING A CONTAINER FOR A MEDIUM

(71) Applicant: Endress+Hauser GmbH+Co. KG, Maulburg (DE)

(72) Inventor: Dietmar SPANKE, Steinen (DE)

(21) Appl. No.: 15/514,080

(22) PCT Filed: Sep. 2, 2015
(86) PCT No.: PCT/EP2015/070016

§ 371 Date: Aug. 29, 2017

(30) Foreign Application Priority Data
Sep. 26, 2014 (DE) 10 2014 113 993.3

(51) Int. Cl. B22F 3/105; B33Y 50/02; B33Y 80/00; B29C 64/393

(52) U.S. Cl. CPC B22F 3/1055; B33Y 50/02; G01F 23/2966; B29C 64/393; B33Y 80/00

(57) ABSTRACT

The present disclosure relates to a method for producing a container for a medium, the container having a probe unit on one wall. The method comprises the steps of creating a three-dimensional model of the container comprising the integrated probe unit and additive layer manufacture of the container comprising the integrated probe unit from at least one raw material according to the three-dimensional model.

The invention relates to a method for producing a container for a medium, wherein the container has a probe unit on one wall. The invention likewise relates to a container that is produced by means of the method according to the invention.

For example, the container may be a container or tank for storing a liquid medium or a bulk good for a fill level measurement device. Furthermore, the container may be a conduit or a measurement pipe of a volume or mass flow rate measurement device. Such flow rate measurement devices are produced and distributed by the applicant as in-line flow rate measurement devices, or as clamp-on flow rate measurement devices.

With both the in-line flow rate measurement devices and the clamp-on flow rate measurement devices, ultrasonic measurement signals are injected into the conduit in which the medium flows, or radiated from the conduit, at a predetermined angle. With ultrasonic flow rate measurement devices, the respective position of the ultrasonic transducer is at the measurement pipe (in-line) or at the conduit (clamp-on). Ultrasonic flow rate measurement devices operate according to the delay time difference method and have at least one pair of ultrasonic probes that emit and/or receive ultrasonic measurement signals along defined sound paths. The ultrasonic probes are arranged so that the sound paths traversing them are directed through the central region of the conduit or measurement pipe. A control and evaluation unit determines the volume flow rate and/or mass flow rate of the medium in the conduit or measurement pipe using the difference between the delays in the measurement signals in the flow direction of the medium and counter to the flow direction of the medium.

In the fill level measurement, the fill level of fluids and bulk goods in a container is detected by means of fill level measurement devices. Fill level measurement devices are used in industry to monitor a predetermined fill level of a fluid, often as an overfill safeguard or dry-run protection in pumps. A distinction is made between continuous measurement by means of fill level sensors and fill level limit switches.

A vibronic limit level switch comprises a probe capable of oscillation, an electromechanical transducer unit for exciting the oscillation-capable probe to mechanical oscillation by means of electrical transmission signals and for receiving the mechanical oscillation of the oscillation-capable probe, and transducing said mechanical oscillation into an electrical reception signal. The vibronic limit switch also comprises an evaluation unit which, using the frequency of the reception signal, determines whether the oscillation-capable probe is covered with medium.

For example, fill level sensors operate with a radar probe or a TDR probe.

Radar probes operate with high-frequency radar pulses that are radiated from an antenna and reflected by the bulk material surface. The duration of the reflected radar pulse is directly proportional to the traveled path. With known container geometry, the fill level can be calculated from this. A horn antenna, preferably, is used for the radar probe.

TDR probes operate with high-frequency radar pulses that are directed along a rod. When the pulses strike the media surface, the wave resistance changes, and a portion of the transmission pulse is reflected. The time period that is measured and evaluated by the device between the transmission and the reception of the reflected pulse is a direct measurement of the distance between process injection and the media surface.

All measurement methods that have previously been described require an additional opening in the container through which the probe is to be introduced. The additional opening must be closed by means of a flange connection and sealed against the medium by means of sealant. These steps involve effort and cost.

The invention is based upon the aim of specifying a method for producing a container, in which method the container has no additional opening (for example, for a probe).

The aim is achieved by the subject matter of the invention. The subject matter of the invention is a method for producing a container for a medium, wherein the container has on one wall a probe unit, said method including the steps of creating a three-dimensional model of the container with integrated probe unit and additive layer manufacture of the container with integrated probe unit from at least one raw material according to the three-dimensional model.

The container in the sense of the invention is a container having an integrated probe unit. In the method according to the invention, it is advantageous that the container with an integrated probe unit on one wall of the container is additively manufactured in one process. The probe unit is subsequently connected via the wall of the container with a transmission/reception unit. In this way, the container has no additional opening for a probe unit or for a transmission/reception unit. Furthermore, it is advantageous that the container according to the invention may be designed to be “disposable.” This means that the container is designed as what is known as a disposable product. Such products are cost-effective and can be manufactured without great effort according to customer desires, and may be directly used well in hygienic or foodstuffs fields and pharmaceutical fields.

According to an advantageous development, the production of the container is done by means of an additive manufacturing method—especially, a 3-D printing method.

A 3-D printer is a machine that forms three-dimensional workpieces, wherein the formation proceeds from one or more liquid or solid raw materials according to predetermined sizes and shapes, under computer control (CAD). Physical or chemical curing or fusing processes occur in the formation. Typical raw materials for 3-D printing methods are plastics, plastic resins, ceramics, and metals.

According to one advantageous variant, rapid prototyping (rapid modeling)—especially, fused deposition modeling or multi-jet modeling—is used to produce the container.

Rapid prototyping (rapid modeling) is the umbrella term for various methods for rapid production of sample components from design data.

Rapid prototyping is a manufacturing method that directly and quickly translates existing electronic data of the three-dimensional model of the container into a container—optimally, without manual redirection or configuration. The methods that have come to be termed rapid prototyping are prototyping methods that form the container in layers from shapeless or shape-neutral raw material using physical and/or chemical effects.

Fused deposition modeling denotes a manufacturing method from the field of rapid prototyping with which the container is formed in layers from a fusible plastic. Machines for fused deposition modeling belong to the 3-D printer machine class. This method is based upon the liquefaction of a wire-shaped plastic or wax material via heating. The raw material solidifies upon subsequent cooling. The raw material application takes place via extrusion with a heated nozzle that can be freely moved in the manufacturing plane. In layered model production, the individual layers therefore bond together into a container.

The term multi-jet modeling refers to a method of rapid prototyping in which the container is constructed in layers via a print head having multiple, linearly-arranged nozzles that functions similarly to the print head of an inkjet printer. Machines with which multi-jet modeling is executed belong to the 3-D printer machine class. Due to the small size of the droplets generated with these systems, fine details of the container may also be depicted.

UV-sensitive photopolymers are used as raw material. These raw materials in the form of monomers are polymerized by means of UV light immediately after being “printed” onto the already present layers, and are thereby transitioned from the initial liquid state to the solid final state.

According to an expedient, advantageous embodiment, selective laser sintering (SLS), laser deposit welding, or plastic freeforming are used to produce the container.

Selective laser sintering is a 3-D printing method for producing the container via sintering from a powdered raw material.

Laser sintering is an additive layer manufacturing method: The container is constructed layer by layer. Arbitrary three-dimensional geometries may be produced via the action of the laser beams, e.g., containers that cannot be produced by conventional mechanical or casting manufacturing.

As a laser, a CO2 laser, an Nd:YAG laser, or a fiber laser is most often used. The powdered raw material is, for example, polyamide or another plastic, a plastic-coated molding sand, a metal powder, or a ceramic powder.

The powder is applied to the entire surface of a manufacturing platform with the aid of a blade or roller. The layers are sintered or fused together step by step via an activation of the laser beam corresponding to the layer contour of the component. The manufacturing platform is now lowered slightly, and a new layer is applied. The powder is provided by raising a powder platform or as a reservoir in the blade. The processing takes place step by step in the vertical direction. The energy that is supplied by the laser is absorbed by the powder and leads to a locally limited sintering or fusing of particles, with reduction of the total surface.

Various method variants are differentiated. In the classical variant, the powder grains are only partially fused; a quasi-liquid phase sintering process occurs. This variant is used in sintering of plastic, and, in part, in sintering of metal with special sintering powders.

The direct use of metallic powders without the addition of a binder is also possible. The metal powders are thereby completely fused. CW lasers are normally used for this. This method variant is also called selective laser melting (SLM).

Laser deposit welding is part of the cladding process (build-up welding), in which a surface is applied to a workpiece by means of fusing and simultaneous application of practically any raw material. This may occur in powdered form, e.g., as a metal powder, or also with a welding wire or ribbon. In laser deposit welding, a high-power laser (predominantly diode lasers or fiber lasers, but, in the past, also CO2 and Nd:YAG lasers) serves as a heat source.

In laser deposit welding with powder, the laser mostly heats the workpiece while defocused and locally fuses it. An inert gas mixed with fine metal powder is simultaneously supplied. The supply of the active area with the metal/gas mixture takes place via trailing or coaxial nozzles. At the heated location, the metal powder fuses and bonds with the metal of the workpiece. In addition to metal powders, ceramic powder materials and special resins may also be used. Laser deposit welding with wire or ribbon functions analogously to the method with powder, but with wire or ribbon as an additive material.

What is known as a freeformer is used in plastic freeforming. As in injection molding, the freeformer melts plastic granulates and generates droplets from the fluid melt, from which droplets the container is formed additively i.e., layer by layer. Individual part production from 3-D CAD component data is therefore possible entirely without an injection molding tool.

In principle, the raw material preparation functions as in injection molding. The granulate is filled into the machine. A heated plasticizing cylinder conducts the plastic melt to a deposition unit. Its nozzle seal with high-frequency piezotechnology enables rapid opening and closing movements, and thus generates the plastic droplets under pressure, from which plastic droplets the plastic part is additively built up without dust or emissions.

In the freeformer, the deposition unit with nozzle remains precisely in its vertical position. Instead, the component carrier moves. In addition to a component carrier that can move serially along three axes, a variant with five axes is optionally available. Since the device possesses two deposition units, two raw materials or colors may also be processed in combination.

The aim of the invention is likewise achieved via a container for a medium that is produced via the method according to the invention, wherein the container has the probe unit at a predetermined position of the wall of the container, wherein the container and the probe unit are formed as one piece. The container is a direct product of the method according to the invention.

According to an advantageous embodiment, the container and the probe unit are formed from the same raw material or from different raw materials. If the container and the probe unit are produced as one piece from one raw material, the container may be produced in one work step. If the container and the probe unit are made from two or more different raw materials, the container or the probe unit may be adapted to different media via the selection of the raw materials.

According to an advantageous embodiment, the probe unit is formed as an oscillating fork, a horn antenna, a TDR rod, or a Coriolis mass flow rate measurement device. The probe unit or the container may be used for measuring a fill level, a limit level, or a flow rate.

According to one advantageous variant, the raw material comprises polystyrene (PS), polypropylene (PP), polyether ether ketone (PEEK), and polyamide (PA)—especially, with additives such as glass fiber, carbon fiber, glass beads, or aluminum. Metals, glass, and diverse fibers in the plastic strengthen the container and make it more stable and durable.

According to an advantageous embodiment, the raw material comprises aluminum, titanium, cobalt, chromium, steel (especially, stainless steel), gold, nickel (especially, nickel alloys). Diverse metals are particularly well suited for making the container stable and robust.

According to an advantageous development, the container has a membrane on a wall with the probe unit, wherein the membrane has a lesser thickness than the wall of the container. Upon excitation of the membrane, the thinner wall of the membrane leads to the oscillations of the membrane—strongly attenuated—being transferred to the wall of the container.

The invention is explained in more detail based upon the following drawings. Illustrated are:

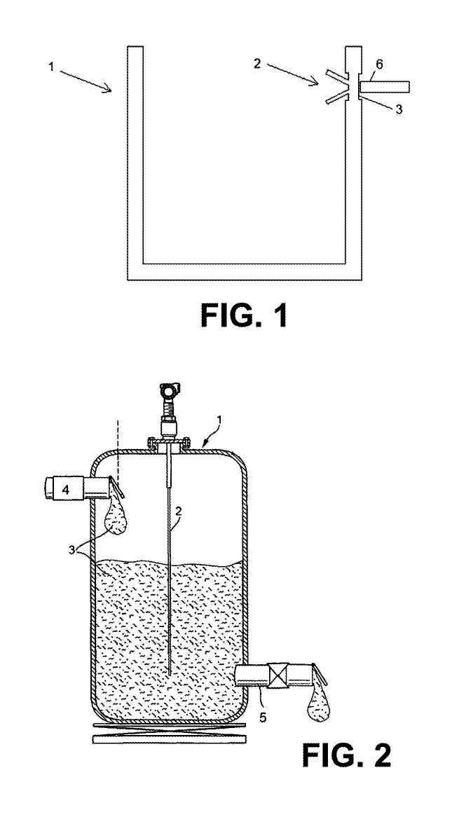

FIG. 1: a longitudinal section of a container according to the invention with an oscillating fork, and

FIG. 2: a longitudinal section of a container according to the invention with a TDR probe.

FIG. 1 shows a longitudinal section of a container 1 having an integrated probe 2 for a medium, said container 1 being produced via a method according to the invention. The container 1 has a lesser wall thickness at a predetermined position of the wall of said container 1. This location with lesser wall thickness serves as a membrane 3. A transmission/reception unit 6 is contacted with the membrane 3 from outside the container 1 so that said transmission/reception unit excites the membrane 3 to oscillation and receives and evaluates oscillations of the membrane 3. On a side situated opposite the transmission/reception unit, the membrane 3 has the probe unit 2 that protrudes into the inside of the container 1, wherein the probe unit 2 is designed as an oscillating fork. The container 1, the membrane 3, and the oscillating fork 2 are formed in one piece from stainless steel. Alternatively, the probe unit 2 may be made of plastic and the container 1 of stainless steel, or vice versa. The container 1 may also be designed as a disposable product.

For producing a container 1 and/or the probe unit 2 according to the invention from stainless steel, corresponding to FIG. 1, selective laser sintering (SLS) is advantageous. However, if the container 1 and/or the probe unit 2 should be produced from a plastic, it is recommended that the container 1 be produced by means of fused deposition modeling.

The electronic data of the three-dimensional model of the container are supplied to customers. The electronic data include several options which form the container in such a way that the container is adapted to a specific medium. The customer may thus print out the container for a one-time use of a medium, and subsequently discard it.

FIG. 2 shows a longitudinal section of a container 1 according to the invention, with a probe unit 2 integrated with the container 1, which probe unit 2 is designed as a TDR probe 2. The container 1 and TDR probe 2 may be formed as one piece from stainless steel or from a plastic. However, the container 1 and TDR probe 2 may also be produced from different materials. For example, the container 1 may be made of plastic, and the TDR probe 2 may be made of stainless steel. A container 1 produced from a plastic is designed as a disposable product. In this way, it is possible to relay only the electronic data of the three-dimensional model of the container 1 to the customers. The customer may then print the container for a specific medium.

The container 1 is formed from metal or a plastic via the method according to the invention. If the container 1 and/or the TDR probe 2 are to be formed from metal, selective laser sintering (SLS) is advantageous as a 3-D printing method. In SLS, the container 1 is sintered from a metal powder. The unsintered powder inside the container 1 may be removed via an inlet opening 4 or an outlet opening 5 through which a medium 3 can flow in and out.

Fused deposition modeling is advantageous for a container 1 and/or a TDR probe 2 made of a plastic. The inside of the container 1 is to be supported with a support material, so that an upper part of the container 1 does not collapse during the 3-D printing process. The support material may be washed or flushed out of the container 1 through the inlet opening 4 or the outlet opening 5 after the printing process.

1-10. (canceled)

11. A method for producing a container for a medium, the method comprising:
creating a three-dimensional model of a container including an integrated probe unit disposed on a wall of the container; and
producing the container and the integrated probe unit from at least one raw material according to the three-dimensional model via additive layer manufacturing.

12. The method of claim 11, wherein the container is produced using a three-dimensional printing method.

13. The method of claim 11, wherein the container is produced by fused deposition modeling or multi-jet modeling.

14. The method of claim 11, wherein the container is produced by selective laser sintering, laser deposition welding, or plastic freeforming.

15. A container for a medium, the container comprising:
a wall defining the container; and
a probe unit disposed at a predetermined position on the wall and formed integral with the wall, wherein the container and probe unit are manufactured by creating a three-dimensional model of the container and the probe unit and by producing the container and the probe unit from at least one raw material according to the three-dimensional model via additive layer manufacturing.

16. The container of claim 15, wherein the container and the probe unit are formed from the same raw material.

17. The container of claim 15, wherein the container and the probe unit are formed from different raw materials.

18. The container of claim 15, wherein the probe unit is an oscillating fork, a horn antenna, a TDR rod, or a Coriolis mass flow rate measurement device.

19. The container of claim 15, wherein the raw material includes polystyrene, polypropylene, polyether ether ketone or polyamide.

20. The container of claim 15, wherein the raw material includes an additive.

21. The container of claim 20, wherein the additive includes glass fiber, carbon fiber, glass beads, aluminum or a combination thereof.

22. The container of claim 15, wherein the raw material includes aluminum, titanium, cobalt, chromium, steel, stainless steel, gold, nickel or nickel alloy.

23. The container of claim 15, wherein the container includes a membrane formed in the wall adjacent the probe unit, wherein the membrane has a lesser thickness than the wall of the container.
